(19) United States
(12) Patent Application Publication
(10) Pub. No.: US 2019/0256762 A1
(43) Pub. Date: Aug. 22, 2019

(54) SCALE INHIBITOR COMPOSITIONS INCLUDING TRIAMINONONANE PHOSPHONATES AND METHODS FOR MAKING AND USING SAME

(71) Applicant: PfP Industries, LLC, Houston, TX (US)

(72) Inventors: Aziz Hikem, Houston, TX (US); Madhukar Chetty, Houston, TX (US)

(21) Appl. No.: 16/243,219

(22) Filed: Jan. 9, 2019

Related U.S. Application Data
(60) Provisional application No. 62/615,384, filed on Jan. 9, 2018.

(51) Int. Cl. C09K 8/528; C07F 9/48

(52) U.S. Cl. CPC C09K 8/528; C07F 9/48

(57) ABSTRACT

Scale inhibiting compositions including at least one triaminononane or 4-aminomethyl-1,8-octanediamine (TAN) phosphonate compound or a salt thereof, and methods for making and using same.

### RELATED APPLICATIONS

This application claims the benefit of and provisional priority of U.S. Provisional Patent Application Ser. No. 62/615,384 filed 9 Jan. 2018.

### BACKGROUND OF THE DISCLOSURE

### 1. Field of the Invention

Embodiments of the present disclosure relate to scale inhibiting compositions including at least one triaminononane or 4-aminomethyl-1,8-octanediamine (TAN) phosphonate compound or a salt thereof, and methods for making and using same.

In particular, embodiments of the present disclosure relate to scale inhibiting compositions including at least one triaminononane or 4-aminomethyl-1,8-octanediamine (TAN) phosphonate compound or a salt thereof, wherein the TAN phosphonates are given by the general Formula (I):

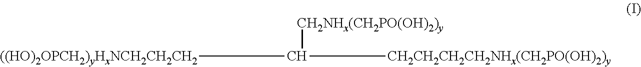

wherein each x and y are independently an integer having a value of 0, 1, or 2, provided that the sum of each x and y is 2, and at least one y is greater than 0, and methods for making and using same.

### 2. Description of the Related Art

Many scale inhibitors have been proposed, prepared, and sold for using in conjunction with downhole fluids. Many of these scale inhibitors include a phosphorus containing moiety. However, there is still a need in the art for scale inhibitor and scale inhibiting compositions for use in downhole fluids and in other fluids that contain scale forming contaminants.

### SUMMARY OF THE DISCLOSURE

Embodiments of this disclosure provide scale inhibiting compositions including a reaction product of 4-aminomethyl-1,8-octanediamine (TAN) and phosphorous acid in the presence of a formylating agent or a salt thereof, where the salt may be an alkali salt (Li, Na, K, Rb or Cs).

Embodiments of this disclosure provide scale inhibiting compositions including at least one TAN phosphonate of the general Formula (I):

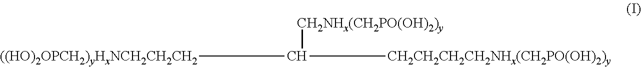

wherein each x and y are independently an integer having a value of 0, 1, or 2, provided that the sum of each x and y is 2, and at least one y is greater than 0.

Embodiments of this disclosure provide methods adding an effective amount of at least one TAN phosphonate of Formula (I) to a downhole fluid, wherein the effective amount is sufficient to inhibit scale formation and ranges between about 0.1 ppm and about 1,000 ppm.

Embodiments of this disclosure provide methods for making TAN phosphonate including contacting TAN with phophorous acid and a formylating agent under conditions sufficient to prepare one or more compounds of Formula (I). In certain embodiments, the methods include contacting TAN with phosphorous acid in the presence of hydrochloric acid at a first reaction temperature for a first reaction time and adding a formylating agent to the reaction mixture at a second reaction temperature for a second rejection time to form the compounds of Formula (I).

### BRIEF DESCRIPTION OF THE DRAWINGS

The invention can be better understood with reference to the following detailed description together with the appended illustrative drawings in which like elements are numbered the same:

FIG. 1 depicts a synthetic scheme for forming N,N,N′,N′,N″,N″-pentakis-(methylphosphonate)-4-aminomethyl-1,8-octanediamine (TAN phosphonate).

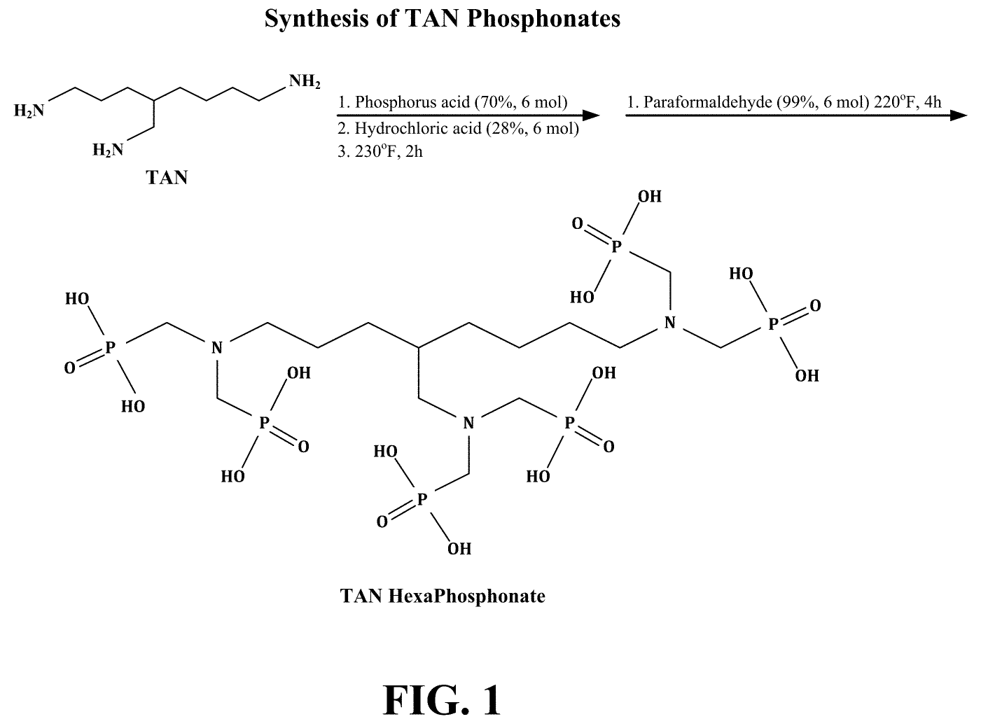

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value.

The term “gpt” means gallons per thousand gallons.

The term “gptg” means gallons per thousand gallons.

The term “pptg” means pounds per thousand gallons.

The term “ppm” means parts per million.

The term “wt. %” means weight percent.

The term “w/w” means weight per weight.

The term “SG” means specific gravity.

### DETAILED DESCRIPTION OF THE DISCLOSURE

The inventors have found that new scale inhibitors may be prepared by reacting 4-aminomethyl-1,8-octanediamine (TAN) with phosphorous acid in the presence of a formylating agent. The inventors have found that the new scale inhibitors are reaction products of TAN and phophorous acid in the presence of a formylating agent under reaction conditions sufficient to convert at least one hydrogen on at least one amine group of TAN to a methylphophonate group (—(CH₂PO(OH₂) group) to form a TAN phosphonate compound. The inventors have prepared TAN phosphonate compounds, where all 6 amine hydrogens of TAN have been converted to methylphophonate groups. The inventors have found that the extent of phosphonation may be controlled by the relative concentration of phosphorous acid and the formylating agent compared to TAN used in the reaction mixture. The inventors have also found that these TAN phosphonate inhibitors are active a low concentration, but may be used in the range between 0.1 ppm and 1,000 ppm, with higher and lower ppm concentration being effective in certain fluids, where the amount of scale forming components may be very low or very high.

Embodiments of this disclosure broadly relate to scale inhibiting compositions including at least one TAN phosphonate of the general Formula (I):

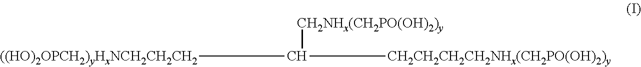

wherein each x and y are independently an integer having a value of 0, 1, or 2, provided that the sum of each x and y is 2, and at least one y is greater than 0. In certain embodiment, each y is equal to 1 or 2 and each x is equal to 1 or 0 at least one amine hydrogen on each amine group is replaced by a phosphonate group. In other embodiments, each y is equal to 2 and each x is equal to 0 each amine nitrogen is replaced by a phosphonate group.

Embodiments of this disclosure broadly relate to methods adding an effective amount of at least one TAN phosphonate of Formula (I) to a downhole fluid, wherein the effective amount is sufficient to inhibit scale formation and ranges between about 0.1 ppm and about 1,000 ppm. In certain embodiment, the effective amount is between about 0.1 ppm and about 500 ppm. In other embodiments, the effective amount is between about 0.1 ppm and about 400 ppm. In other embodiments, the effective amount is between about 0.1 ppm and about 300 ppm. In other embodiments, the effective amount is between about 0.1 ppm and about 200 ppm. In other embodiments, the effective amount is between about 0.1 ppm and about 100 ppm. In other embodiments, the effective amount is between about 0.1 ppm and about 50 ppm. In other embodiments, the effective amount is between about 1 ppm and about 50 ppm. In other embodiments, the effective amount is between about 5 ppm and about 25 ppm. In other embodiments, the effective amount is between about 5 ppm and about 20 ppm.

Embodiments of this disclosure broadly relate to methods for making TAN phosphonate including contacting TAN with phophorous acid in the presence of a formylating agent under conditions sufficient to prepare one or more compounds of Formula (I), where the reaction conditions include a period of time and a temperature sufficient to convert one or more amine hydrogen to a methylphosphonate groups. The time period is generally between about 0.5 hours and 12 hours and the temperature is generally between 100° F. and 250° F.

Embodiments of this disclosure broadly relate to methods for making TAN phosphonate including contacting TAN with phosphorous acid in the presence of hydrochloric acid at a first reaction temperature for a first reaction time and adding a formylating agent to the reaction mixture at a second reaction temperature for a second rejection time to form the compounds of Formula (I). In certain embodiments, the first reaction time is between about 0.5 hours and about 4 hours, the first reaction temperature is between about 110° F. and about 150° F., the second reaction time is between about 1 hour and 12 hours, and the second reaction temperature is between about 200° F. and about 250° F. In certain embodiments, the TAN is added slowly to the phosphorous acid/hydrochloride acid reaction mixture over a period of time between about 1 hours and about 2 hours at a temperature between about 110° F. and 150° F. and the formylating agent is added slowly to the resulting reaction mixture over a period of time between about 1 hour and about 2 hours at a temperature between about 200° F. and about 250° F., which is maintained for an additional period of about 4 to 12 hours. In certain embodiments, the relative concentrations of phosphorous acid and the formylating agent are sufficient to convert at least one amine hydrogen on at least one of the amino groups to a methylphonate group. In other embodiments, the relative concentrations of phosphorous acid and the formylating agent are sufficient to convert at least one amine hydrogen on each of the amine groups to a methylphonate group. In other embodiments, the relative concentrations of phosphorous acid and the formylating agent are sufficient to convert all amine hydrogens on all of the amine groups to methylphonate groups.

### Suitable Components for Use in the Disclosure

Suitable downhole fluid include, without limitation, fracturing fluids, drilling fluids, completion fluids, production fluids, and other fluids that contain scale forming contaminants.

Suitable formylating agent include, without limitation, formaldehyde, paraformaldehyde, methyl formcel, methyl formal, any formaldehyde donor, or mixtures and combinations thereof.

Suitable triaminononane or 4-aminomethyl-1,8-octanediamine (TAN) starting materials include, without limitation, HEXATRAN™ 200 and HEXATRAN™ 300 (tradenames of Ascend Performance Materials LLC), Achem062208 available from Chemhere CO., LTD, CTKOE7331 available from ChemTik, 3B1-001730 and LP004832 available from 1717 CheMall Corporation, AKOS006271894 available from AKos Consulting & Solutions, A17.886.003 available from Aurora Fine Chemicals LLC, KB-240228 available from Nanjing Kaimubo, 419176 ALDRICH available from Sigma-Aldrich, or mixtures and combinations thereof.

### EXPERIMENTS OF THE DISCLOSURE

### Synthesis of Tan Phosphonates

TAN (triaminononane or 4-aminomethyl-1,8-octanediamine) was obtained from Ascend Performance Materials LLC. Commercial TAN products are available under trade names HEXATRAN™ 200 and HEXATRAN™ 300 and are basically mixture of proprietary amines. The commercial TAN products were used as received. The formylating agent was formaldehyde used either as solid paraformaldehyde or a 37 wt. % formaldehyde solution in water. Phosphorous acid (HPO(OH)₂) was used in crystal form or dissolved in water prior to transferring into reactor.

All percent solids were determined at 105° C. using Mettle-Toledo, model HB43-S, moisture analyzer.

### Example 1

This example illustrates the preparation of a TAN phosphonate composition using paraformaldehyde as formylating agent.

98.4 g (1.2 mol.) of phosphorous acid (99.0%), 42.2 g of deionized water, 66.2 g (0.51 mol.) of hydrochloric acid (28.0 wt. %) were charged into a 0.5 L resin kettle reactor equipped with a thermocouple, Allihn water condenser, and a 100 mL addition funnel. 36.5 g (0.2 mol.) of HEXATRAN™ 200 (95.0%) were transferred to dropping funnel. The contents of the reactor were stirred using an overhead stirrer (Caframo Company, BDC 6015). The reaction mixture was stirred at 300 rpm, and at the same time the HEXATRAN™ 200 was slowly to the reactor. As reaction proceeded, heat was generated via an exotherm. The slow addition of HEXATRAN™ 200 was completed over 90 minutes at temperature at or below 110° F. The reactor kettle was then placed on a heating mantle and heated to 140° F. 36.0 g (1.1 mol.) paraformaldehyde (95.0%) were slowly added via a powder dispensing funnel. The paraformaldehyde addition was completed over 2 hour period of time. The reaction temperature rose to 208° F. The reaction was continued for additional 5 hours and the temperature ranged between 208° F. and 225° F.

The final liquid product was acidic having a pH of −0.61 with a reddish color. The final liquid product was partially neutralized to pH=2.5 by adding 72.0 g of 30 wt. % ammonium hydroxide.

The final product had the following properties: pH=2.5, SG=1.24, and solids=59.1%.

### Example 2

This example illustrates another preparation of a TAN phosphonate composition using paraformaldehyde as formylating agent.

49.0 g (0.6 mol.) of phosphorous acid (99.0%), 14.7 g of deionized water, 39.0 g (0.3 mol.) of hydrochloric acid (28 wt. %) were charged into a 0.5 L resin kettle reactor equipped with a thermocouple, Allihn water condenser, and a 100 mL addition funnel. 36.5 g (0.2 mol.) of HEXATRAN™ 200 (95.0%) via the addition funnel. The reaction mixture was stirred using overhead stirrer (Caframo company, BDC 6015) to 300 rpm. The HEXATRAN™ 200 was then slowly added to the reactor. As reaction proceeds, an exotherm was observed. The slow addition of HEXATRAN™ 200 was completed over 45 minutes and the temperature was contained at or below 130° F. The reactor was then placed on a heating mantle and heated to 221° F. over 2 hours. The reaction mixture was cooled to 176° F. and 18.0 g (0.6 mol.) of paraformaldehyde (95.0%) were slowly added via powder dispensing funnel. Complete addition of paraformaldehyde took about an hour with temperature reaching 194° F. Heating of reaction mixture was continued for an additional 5.0 hour and the temperature ranged from 194° F. to 221° F.

The final liquid product acidic a pH of 0.32 with a reddish color. The final product was then partially neutralized to a pH of 2.7 by adding 42.5 g of 20 wt. % sodium hydroxide.

The final product had the following properties: pH=2.7, SG=1.23, and solids=57.2%.

### Example 3

This example illustrates another preparation of a TAN phosphonate composition using paraformaldehyde as formylating agent.

49.0 g (0.6 mol.) of phosphorous acid (99%), 15 g (0.3 mol.) of deionized water, 39.0 g of hydrochloric acid (28%) into a 0.5 L resin kettle reactor equipped with a thermocouple, Allihn water condenser, and a 100 mL addition funnel. 36.5 g (0.2 mol.) of HEXATRAN™ 200 (95.0%) were transferred into the reaction via the addition funnel. The reaction mixture was stirred using an overhead stirrer (Caframo company, BDC 6015) to 300 rpm. The HEXATRAN™ 200 was slowly added to the reactor. As reaction proceeds, an exotherm was observed. The addition of HEXATRAN™ 200 was completed over 40 minutes and the temperature was contained at or below 122° F. The reactor was then placed on a heating mantle and the reaction mixture was heated to 212° F. over 1.5 hours. 51.0 g (0.62 mol.) of a 37.0 wt. % formaldehyde aqueous solution was added to the reaction mixture slowly over 30 minutes and the temperature was maintained between 212° F. and 221° F. Heating of the reactor reaction mixture was continued for an additional 5 hours and heated to a temperature of 226° F.

The final product had the following properties: pH=0.39, SG=1.34, and solids=60.0%.

### Example 4

This example illustrates another preparation of a TAN phosphonate composition using paraformaldehyde as formylating agent.

98.4 g (1.2 mol.) Of phosphorous acid (99%), 25.0 g DI water, 50.1 g (0.5 mol.) hydrochloric acid (37.0 wt. %) were charged into a 0.5 L resin kettle reactor equipped with a thermocouple, Allihn water condenser, and a 100 mL addition funnel. 46.2 g (0.27 mol.) of HEXATRAN™ 300, (75.0%) was added to the reactor via the addition funnel. The contents of the reactor were stirred using an overhead stirrer (Caframo company, BDC 6015) beginning at 300 rpm and at same time the HEXATRAN™ 300 addition was added slowly to the reactor. As reaction proceeds, an exotherm was observed. The addition of HEXATRAN™ 300 was completed over 30 minutes and temperature was maintained at or below 167° F. The reactor was then placed on a heating mantle and heated to 226° F. over 3.5 hours. Using a powder dispensing funnel, 36.1 g (1.2 mol.) of paraformaldehyde (92%) were slowly added to the reactor over 2 hours. The reaction mixture was maintained at the same temperature for additional 3 hours.

Properties of final product: pH=0.4, SG=1.34, and solids=70.5%.

### Example 5

This example illustrates another preparation of a TAN phosphonate composition using paraformaldehyde as formylating agent using the procedure of Example 4, except that order and amounts are set forth below:

| Order | Material | Amount |
|---|---|---|
| 1 | phosphorous acid (99%) | 196.8 g, 2.4 mol. |
| 2 | DI water | 84.3 g, |
| 3 | formaldehyde (37 wt. %) | 72.1 g, 2.4 mol., |
| 4 | Hydrochloric acid (37 wt. %) | 100.2 g, 1.0 mol. |
| 5 | TAN (75%) | 92.4 g, 0.53 mol. |

Properties of final product: pH=0.3, SG=1.27 and % solids 58.4.

### Example 6

This example illustrates another preparation of a TAN phosphonate composition using paraformaldehyde as formylating agent using the procedure of Example 4, except that order and amounts are set forth below:

| Order | Material | Amount |
|---|---|---|
| 1 | phosphorous acid (99%) | 196.8 g, 2.4 mol |
| 2 | DI water | 84.3 g |
| 3 | hydrochloric acid (37%) | 100.2 g, 1.0 mol |
| 4 | TAN (75%) | 92.4 g, 0.53 mol |
| 5 | Formaldehyde (37%) | 72.1 g, 2.4 mol |

Properties of final product: pH=0.25, SG=1.26, and % solids 57.3.

### Scale Inhibition Test for Calcium Carbonate Precipitation

The above TAN phosphonate compositions were tested for scale inhibition using NACE standard test TM0374-2007 method. All scale inhibitor solutions were prepared in DI water.

Inhibitor of Examples 1, Example 2, and Example 3 were tested against and a commercially available LUBRIZOL® product IS 32. The test solutions were prepared by dissolving appropriate amounts of scale inhibitors in DI water. The testing showed that the inhibitors were effective in concentrations ranging between 6.1 ppm and 12.9 ppm.

The steps for the calcium carbonate scale inhibition testing are as follows:
1. Calcium containing brine was prepared by dissolving 12.15 g of calcium chloride dihydrate and 3.68 g of magnesium chloride hexahydrate in 1 L DI water.
2. Bicarbonate containing brine was prepared by dissolving 7.36 g sodium bicarbonate and 33.0 g sodium chloride in 1 L DI water
3. Saturate both calcium containing brine and bicarbonate containing brine with gaseous carbon dioxide for 0.5 hours at a rate of 250 mL/min (recommended).
4. Transfer 50.0 mL of bicarbonate containing brine into a 125 mL clean glass test cell provided with screw cap. Add scale inhibitor to be tested to the capped test cell and shake to mix solutions. Then add 50.0 mL of the calcium containing brine to the capped test cell immediately and mix thoroughly.
5. Prepare a blank sample without scale inhibitor.
6. Place glass test cells in a forced air Iso temp 700 series oven (Fisher Scientific model no. 6952) at 71° C. and heat for 24 hours.
6. After 24 hours, the test cells were cooled to 20° C., prior to estimating calcium in solution using digital titrator (Hach method: 8204 is employed to estimate calcium in solution).

Percent inhibition calculated using following equation:

inhibition=(Ca−Cb)/(Cc−Cb)×100

where Ca is the calcium concentration from test cells after heating in the oven, Cb is the calcium concentration in blank test cell after heating in the oven, and Cc is the half calcium concentration of the test brine of step 1 above.

Table 1 tabulates the physical properties of scale inhibitors, e.g., pH, percent solids, ppm used in scale inhibition experiments, % inhibition result, and the pH of test solution.

TABLE I
Comparative Performance Scale Inhibition Using NACE Test
(method TM 0374-2007) at @ 71° C. for 24 hours

| | | | Conc. | | pH (test |
|---|---|---|---|---|---|
| Scale Inhibitor | pH | % solids | (ppm) | % Inhibition | solution) |
| Lubrizol ® IS 32 | 1.69 | 58.1 | 6.1 | 50 | 6.22 |
| | | | 12.1 | 78 | 6.45 |
| Example 1 | 2.5 | 59.1 | 6.2 | 96.9 | 6.43 |
| | | | 12.4 | 103.1 | 6.47 |
| Example 2 | 0.32 | 57.2 | 6.5 | 65.6 | 6.38 |
| | | | 12.9 | 103.1 | 6.43 |
| Example 3 | 0.39 | 60 | 6.2 | 90.6 | 6.22 |
| | | | 12.4 | 106.3 | 6.41 |

NOTE:
ppm based on scale inhibitor product, not adjusted to percent solids.

### Scale Inhibition Test for Calcium Sulfate Precipitation

The TAN phosphonate composition were tested for scale inhibition using NACE standard test TM0374-2007 method. All scale inhibitor solutions were prepared in DI water. The following scale inhibitors are used for inhibition testing: Batch numbers 3004-66-3, 3004-69-1, 3004-70-1 and a commercially available Lubrizol product IS 32 for comparison. Test solutions were prepared by dissolving appropriate amounts of scale inhibitors in DI water. For scale inhibition testing, scale inhibitor concentrations in 6.4-13.4 ppm found to be efficient.

The steps for the calcium carbonate scale inhibition testing are as follows:
1. Calcium containing brine prepared by dissolving a mixture of 11.10 g calcium chloride dihydrate and 7.5 g sodium chloride 1 L DI water.
2. Sulfate containing brine prepared by dissolving a mixture of 10.66 g sodium sulfate and 7.5 g sodium chloride in 1 L DI water
3. Transfer 50.0 ml of sulfate containing brine into 125 ml clean glass test cell provided with screw cap. Add scale inhibitor to be tested, cap test cell and shake to mix solutions. Then add 50.0 ml calcium containing brine, cap test cell immediately and mix thoroughly.
4. Prepare a blank sample without scale inhibitor.
5. Place glass test cells in a forced air Iso temp 700 series oven (Fisher Scientific model no. 6952) at 71 C. Glass bottle cells are heated for 24 h.
6. After 24 h, test cells are cooled to 20 C, prior to estimating calcium in solution by using digital titrator. Hach method: 8204 is employed to estimate calcium in solution.
7. Percent inhibition calculated using equation as shown in 10 above.

Table II also shows physical properties of scale inhibitors, e.g., pH, percent solids, ppm used in scale inhibition experiments and % inhibition result.

TABLE II
Comparative Performance Scale Inhibition Using NACE Test
(Method TM 0374-2007) at @ 71° C. for 24 hours

| | | | | % |
|---|---|---|---|---|
| Scale Inhibitor | pH | % solids | Conc. (ppm) | Inhibition |
| Lubrizol ® IS 32 | 1.69 | 58.1 | 6.6 | 100 |
| | | | 13.3 | 100 |
| Example 4 | 0.4 | 70.5 | 6.4 | 91.7 |
| | | | 12.8 | 100 |
| Example 5 | 0.3 | 58.4 | 6.7 | 100 |
| | | | 13.4 | 100 |
| Example 6 | 0.25 | 57.3 | 6.4 | 91.7 |
| | | | 12.8 | 100 |

NOTE:
ppm based on scale inhibitor product, not adjusted to % solids.

### CLOSING PARAGRAPH

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A scale inhibitor composition comprising:
a reaction product of 4-aminomethyl-1,8-octanediamine (TAN) and phosphorous acid in the presence of a formylating agent under reaction conditions sufficient to convert at least one amine hydrogen of TAN to a methylphosphonate group.

2. The composition of claim 1, wherein the reaction conditions are sufficient to convert at least one amine hydrogen on each amine group of TAN to methylphosphonate groups.

3. The composition of claim 1, wherein the reaction conditions are sufficient to convert all amine hydrogen on all the amine groups of TAN to methylphosphonate groups.

4. The composition of claim 1, wherein the reaction product comprises at least one TAN phosphonates of Formula (I): 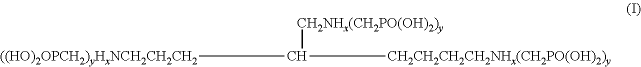
wherein each x and y are independently an integer having a value of 0, 1, or 2, provided that the sum of each x and y is 2, and at least one y is greater than 0.

5. The composition of claim 4, wherein each x has a value of 1 and each y has a value of 1.

6. The composition of claim 4, wherein each x has a value of 0 or 1 and each y has a value of 1 or 2.

7. The composition of claim 4, wherein each x has a value of 0 and each y has a value of 2.

8. A fluid composition comprising:
a downhole fluid and
an effective amount of a reaction product of 4-aminomethyl-1,8-octanediamine (TAN) and phosphorous acid in the presence of a formylating agent under reaction conditions sufficient to convert at least one amine hydrogen to a methylphosphonate group.

9. The composition of claim 8, where in the reaction product comprises at least one TAN phosphonates of Formula (I): 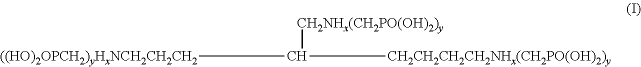
wherein each x and y are independently an integer having a value of 0, 1, or 2, provided that the sum of each x and y is 2, and at least one y is greater than 0.

10. The composition of claim 9, wherein each x has a value of 1 and each y has a value of 1.

11. The composition of claim 9, wherein each x has a value of 0 or 1 and each y has a value of 1 or 2.

12. The composition of claim 9, wherein each x has a value of 0 and each y has a value of 2.

13. A method comprising:
adding, to a fluid, an effective amount of a scale inhibiting composition comprising a reaction product of 4-aminomethyl-1,8-octanediamine (TAN) and phosphorous acid in the presence of a formylating agent under reaction conditions sufficient to convert at least one amine hydrogen to a methylphosphonate group.

14. The method of claim 13, where in the reaction product includes at least one TAN phosphonates of Formula (I): 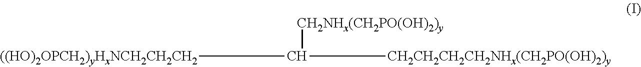
wherein each x and y are independently an integer having a value of 0, 1, or 2, provided that the sum of each x and y is 2, and at least one y is greater than 0.

15. The method of claim 14, wherein each x has a value of 1 and each y has a value of 1.

16. The method of claim 14, wherein each x has a value of 0 or 1 and each y has a value of 1 or 2.

17. The method of claim 14, wherein each x has a value of 0 and each y has a value of 2.

18. A method comprising:
slowly adding 4-aminomethyl-1,8-octanediamine (TAN) to a mixture of phosphorous acid and hydrochloric acid for a first reaction time at a first reaction temperature, and
slowly adding a formylating agent to the resulting reaction mixture for a second reaction time at a second reaction temperature,
wherein the first and second reaction times and the first and second reaction temperatures are sufficient to convert one or all of the amine hydrogen of the amine groups of TAN are converted to methylphosphonate groups.

19. The method of claim 18, where the first and second reaction times and the first and second reaction temperatures are sufficient to convert all or substantially all of the amine hydrogen of the amine groups of TAN are converted to methylphosphonate groups.

20. The method of claim 18, where the first and second reaction times and the first and second reaction temperatures are sufficient to convert all of the amine hydrogen of the amine groups of TAN are converted to methylphosphonate groups.
